(19) United States
(12) Patent Application Publication
(10) Pub. No.: US 2025/0224949 A1
(43) Pub. Date: Jul. 10, 2025

(54) VARIABLE DATA MARKING UNIT WITH MULTIPLE CONNECTIVITY MODES

(71) Applicant: Videojet Technologies, Inc., Wood Dale, IL (US)

(72) Inventors: Andreas Orfanos, Cambridge Science Park (GB); Juan A. Rubio, Vera-Playa, Almeria (ES)

(73) Assignee: Videojet Technologies, Inc., Wood Dale, IL (US)

(21) Appl. No.: 18/838,838

(22) PCT Filed: Feb. 16, 2023
(86) PCT No.: PCT/US2023/013214

§ 371 Date: Aug. 15, 2024

Related U.S. Application Data
(60) Provisional application No. 63/310,820, filed on Feb. 16, 2022.

(51) Int. Cl. G06F 8/65

(52) U.S. Cl. CPC G06F 8/65

(57) ABSTRACT

A marking unit configured for marking variable data content on a product or product packaging, the marking unit including a plurality of interface modules configured to be connected to a global computer network. The plurality of interface modules includes a wired Ethernet connection module, a wireless WI-FI module, and a cellular data module. The marking unit includes instructions for sending or receiving communications, each communication defined by a category selected from the group consisting of: sending telemetric data over a global computer network to a telemetric data collection/remote support node, receiving updates the machine-readable instructions, and receiving variable data content. The included instructions are also for selecting which of the plurality of interface modules to use for sending or receiving each communication based on the category of the communication and whether each of the plurality of interface modules is available.

### CROSS-REFERENCE TO RELATED APPLICATIONS

This application claims priority from U.S. Provisional Application Ser. No. 63/310,820, titled VARIABLE DATA MARKING UNIT WITH MULTIPLE CONNECTIVITY MODES, filed Feb. 16, 2022, incorporated herein by reference in its entirety.

### BACKGROUND OF THE INVENTION

Industrial marking units, including printers configured to apply ink to a surface of a product or product packaging (e.g. ink jet printers or thermal transfer printers, such as those made by Videojet Technologies), or laser marking modules configured to ablate a surface the product or product packaging, are used in production line printing to mark products or product packaging with information related to the product. Some such marking units are configured to print the content of variable data on products or product packaging, such as a date (e.g. a packaging date, an expiration date, or a “sell by” date), an identifying code (e.g. corresponding to a lot or batch of product, a specific manufacturing line or unit on which the product was made), and/or time of manufacture for product tracking purposes, and the like, without limitation.

The marking units as described above are sophisticated devices with many components. For example, for an inkjet printer, some components charge an ink mixture, and other components apply electric fields in order to control movement of droplets of the makeup fluid to form desired patterns on the product or product packaging. These marking units may include various sensors to monitor sensor values associated with one or more components of the unit. For example, sensors at the print head of a printer may be used to monitor the temperature at the print head or monitor the temperature of components of the print head. Temperatures exceeding a desired print head temperature may result in over consumption of solvent which directly affects the viscosity of the ink. To that end sensors may be provided at the ink supply of the printer to monitor the viscosity of the ink. In addition, ink level sensors may be provided to monitor the level of ink remaining in an ink supply tank or an ink make-up tank.

Additionally, the controller of a marking unit may be configured to generate alerts or warnings-based sensor values generated by the sensors. In addition, user interface data and event data are generated for some marking units. For example, user interface data may include print enable/print disable data, which may include the date and time a printer was enabled and then subsequently disabled by an operator, or the date and time of one or more print head cleaning operations. Other data used by some industrial printers include values for user set parameters, such as production line speed, image height and width, distance a substrate is from a print head, and actual print head temperature.

The average ink printer may experience faults periodically due to avoidable issues, such as those caused by lack of attention to consumable (ink) levels or preventative maintenance. While many faults can be resolved without the assistance of the printer maker, not all routinely experienced issues are due to faults, and some may be due to incorrect setup by the end user. Printers tend to be scattered throughout a manufacturing location, often in inconvenient locations. While maintenance teams may be located nearby, they are not always on the manufacturing line floor, and printers may not be the primary focus of the maintenance staff. Often, when faults occur, the printers are not fixed on the floor, but are swapped out and taken to the shop for fixing.

To overcome some of the difficulties inherent in the use of such printers, U.S. Pat. No. 9,524,132, incorporated herein by reference for all purposes, titled SYSTEM AND METHOD FOR REMOTELY SERVICING AN INDUSTRIAL PRINTER, assigned to the assignee of the present invention, discloses a system configured to communicate telemetric sensor and parameter setting data related to the operation of an industrial printer components. The system as described therein includes one or more instances of a communications interface, which may be coupled to a communications network via 20) wired or wireless links. As described therein, sensor data may be communicated via the communications interface to a remote processor from the site where the industrial printer is located, so that the processor can identify service issues based in part on the sensor data, determine an action to be performed on the industrial printer in response to the service issue; and cause the action to be initiated. Additionally, the printer May receive software updates via the communications interface. The remote processor collects data obtained over a period of time from a plurality of different industrial printers located at a plurality of different sites and uses that data to derive historical data that is used for diagnosing issues.

In addition to sending telemetric data to or receiving software updates, marking units configured to mark products with variable data also typically need to receive communications regarding the variable data to be printed, such as from a processor, computer memory, or a user interface, or combinations thereof, without limitation.

A manufacturing location may have a local wired (e.g. LAN or Ethernet) or wireless (e.g. Wi-Fi®) network for communication of information relevant to operations of the manufacturing processes, but may wish to keep that network dedicated for the use of the operator of the manufacturing location for any of a number of reasons. For example, communications traffic, such as telemetric and software download information to and from a printer may take away valuable bandwidth needed for other communications. Every device communicating outside a local network also potentially poses a security threat as a vector for hacking or virus infection. Accordingly, some manufacturing locations may restrict or prohibit certain equipment from communicating via the manufacturing location network. Additionally, communications systems are known to experience outages from time to time that may impede communications. Furthermore, network changes or changes in security within a plant may render a prior printer communications setup inoperable. Also, maintenance on a printer may require the printer to be swapped out, and the printer may not be re-connected when redeployed. Thus, a printer manufacturer at the mercy of plant maintenance or IT groups responsible for setting up a printer that marks product effectively even if not connected to the network and/or transmitting telemetric data, may miss a lot of potential collected data. A suboptimal printer connection rate may lead to a lack of field confidence in the functionality to detect and correct issues remotely.

Thus, impediments to communication inhibit the ability to collect data that may be useful for diagnosing not only issues with printers employed at a specific site, but also printers employed at unrelated sites, and may also inhibit the ability to implement corrective action or software updates. Difficulty in setting up the communications protocol may discourage proper set up from the moment of installation.

Accordingly, there is a need in the art to provide industrial process equipment, such as marking units such as printers, with a communications protocol that maximizes the potential for successful communication.

### SUMMARY OF THE INVENTION

One aspect of the invention relates to a marking unit configured for marking variable data content on a product or product packaging. The marking unit includes a marker module configured to mark the product or product packaging in accordance with the variable data content, at least one computer processor connected to at least one computer memory and the marker module, one or more sensors connected to the computer processor and/or the computer memory, and a plurality of interface modules configured to be connected to a global computer network. The computer memory is programmed with machine-readable instructions for causing the marker module to mark the variable data content on the product or product packaging. Each sensor is configured to generate monitoring data relating to at least one operational variable of marker module, wherein the machine-readable instructions include instructions for causing the at least one computer processor to generate telemetric data corresponding at least in part to the monitoring data. The plurality of interface modules includes a wired Ethernet connection module configured to connect via a wire to an external router connected to the global computer network, a wireless WI-FI module configured to connect wirelessly to an external router connected to the global computer network; and a cellular data module configured to connect wirelessly directly to the global computer network via an on-board router. One or more communication ports are connected to the at least one computer processor and at least one of the plurality of interface modules. The machine-readable instructions include instructions for sending or receiving communications and selecting which of the plurality of interface modules to use for sending or receiving each communication based on the category of the communication and whether each of the plurality of interface modules is available. The communications are defined by a category selected from the group consisting of: (i) sending the telemetric data to a telemetric data collection/remote support node; (ii) receiving remote support communications from the telemetric data collection/remote support node; (iii) receiving updates to the machine-readable instructions; and (iv) receiving the variable data content.

The marking unit interface module may be considered available if it has an active connection to the internet and the marking unit has permission to use that interface module. The instructions for selecting which of the plurality of interface modules to use may include logic configured to cause preferential selection of the cellular data module for sending the telemetric data and for receiving updates to the machine-readable instructions. The instructions for selecting which of the plurality of interface modules to use may include logic configured to cause preferential selection of one of the interface modules other than the cellular data module for receiving the variable data content. In embodiments, the marking unit may be configured to send and receive communications over two or more of the plurality of interface modules simultaneously. The marking unit may include a housing, and the plurality of interface modules may be on-board modules contained within the housing. The monitoring data may also include one or more parameter settings corresponding to the marking module.

In embodiments, the marker module may be a laser marking module configured to ablate a surface of the product or product packaging in accordance with the variable data content, or a printer marking module configured to apply ink to a surface of the product or product packaging in accordance with the variable data content, such as a thermal transfer printer or an inkjet printer, such as a continuous inkjet printer or a thermal inkjet printer.

Another aspect of the invention relates to a method for marking variable data content with a marking unit on a product or product packaging, the marking unit having a processor programmed with machine-readable instructions and a plurality of communications interface modules. The method includes the marking unit sending or receiving one or more communications via one or more of the plurality of communications interface modules, each of the one or more communications defined by a category selected from the group consisting of: (a) sending telemetric data to a telemetric data collection/remote support node, (b) receiving remote support communications from the telemetric data collection/remote support node; (c) receiving updates to machine-readable instructions, and (d) receiving variable data content. The marking unit determines which of the plurality of communications interface modules is available, selects which of a plurality of communications interface modules to use for sending or receiving each communication based on the category of the communication and the determination as to which of the plurality of communications interface modules is available; and receives the variable data content and marking the product or product packaging in accordance with received variable data content. Each of the plurality of communications interface modules may be considered available if it has an active connection to an internet and the marking unit has permission to use that communications interface module.

In embodiments, the plurality of communication interface modules includes at least two of: a wired Ethernet connection module configured to connect via a wire to an external router connected to the global computer network; a wireless WI-FI module configured to connect wirelessly to an external router connected to the global computer network; and a cellular data module configured to connect wirelessly directly to the global computer network via an on-board router. Selecting which of the plurality of communications interface modules to use may include preferential selection of the cellular data module for sending the telemetric data, receiving/sending remote support communications, and for receiving updates to the machine-readable instructions. In some embodiments, selecting which of the plurality of interface modules to use includes preferential selection of one of the communications interface modules other than a cellular data module for receiving the variable data content. The method may include sending or receiving communications comprises sending and receiving communications over two or more of the plurality of interface modules simultaneously.

Marking the product or product packaging may include ablating a surface via laser of the product or product packaging in accordance with the variable data content or applying ink to a surface of the product or product packaging in accordance with the variable data content. The method may further include receiving and processing the telemetric data with a remote processor, identifying a remote support communication for the marking unit based at least in part upon the telemetric data, and sending the remote support communication to the marking unit via the telemetric data collection/remote support node. Processing the telemetric data may include performing predictive analysis, and the remote support communication may include a service communication based upon the predictive analysis of the telemetric data. The method may include receiving an update to the machine-readable instructions and updating the machine-readable instructions, and optionally, storing the machine-readable instructions in a computer memory associated with the marking unit computer processor and updating the machine-readable instructions at a time when the marking unit is not actively engaged in a marking operation, or the marking unit computer processor prompting a user via a user interface associated with the marking unit for authorization and/or a designated date/time to perform the updating of the machine-readable instructions.

Embodiments of the method may include receiving an incoming communication and sending an outgoing communication simultaneously over a cellular data module. Embodiments may also or instead include spooling telemetric data to a computer memory associated with the marking unit while an incoming communication is being received via a cellular data module, and then sending the spooled telemetric data after termination of the incoming communication. The marking unit may inform a sender configured to send communications to the marking unit as to a preferred routing of the plurality of communications interface modules to send the communications. The preferred routing may include identifying at least a first one of the plurality of communications interface modules as a primary route and identifying at least a second one of the plurality of communications interface modules as a secondary route for use when the primary route is unavailable. The step of informing the device may include rejecting at least one communications sent by the device to each of the plurality of communications interface modules that are not in the preferred routing. The step of informing the device may include sending at least one communication to the device via the preferred routing. The method may further include storing instructions corresponding to the preferred routing in computer memory connected to a device associated with the sender.

In some embodiments of the method, initialization of the marking unit may include the marking unit automatically determining which of the plurality of communications interface modules is available, including attempting to automatically establish a connection to the telemetric data collection/remote support node via the cellular data module; automatically receiving any available updates to the machine-readable instructions; automatically selecting which of a plurality of communications interface modules to use for sending or receiving each communication; and automatically informing the sender configured to send communications to the marking unit as to the preferred routing of the plurality of communications. Initialization of the marking unit may be performed without human interaction subsequent to the marking unit being connected to a power source.

Another aspect of the invention relates to a system for marking variable data content on a product or product packaging including the marking unit as described herein, and a variable data content communications sub-system, comprising a content computer processor, a variable data content communicator connected to the content computer processor and in communication with the marking unit, and a content computer memory connected to the content computer processor, the content computer memory programmed with machine-readable instructions for generating variable data content and/or receiving user input corresponding at least in part to the variable data content and for sending variable data content communications to the marking unit. The variable data content communication sub-system may be configured to receive instructions regarding a preferred routing for the variable data content communications; update the machine-readable instructions residing on the content computer memory to include the preferred routing; and communicate the variable data content to the marking unit using the preferred routing.

The marking unit may be programmed with machine-readable instructions to automatically, without human interaction subsequent to the marking unit being connected to a power source, initialize the marking unit by automatically determining which of the plurality of communications interface modules is available, including attempting to automatically establish a connection to the telemetric data collection/remote support node via the cellular data module; automatically receiving any available updates to the machine-readable instructions; automatically selecting which of a plurality of communications interface modules to use for sending or receiving each communication; and automatically informing a sender configured to send communications to the marking unit as to the preferred routing of the plurality of communications.

Another aspect of the invention relates to a variable data content communications device, comprising a content computer processor, a variable data content communicator connected to the content computer processor and in communication with the marking unit, and a content computer memory connected to the content computer processor, the content computer memory programmed with machine-readable instructions for generating variable data content and/or receiving user input corresponding at least in part to the variable data content and for sending variable data content communications to a marking unit. The variable data content communications device is configured to receive instructions from the marking unit regarding a preferred routing of which of a plurality of communications interface modules on the marking unit to use for the variable data content communications; update the machine-readable instructions residing on the content computer memory to include the preferred routing; and communicate the variable data content to the marking unit using the preferred routing.

Yet another aspect of the invention relates to machine readable media programmed with machine readable instructions for causing a processor associated with a variable data content communications device in communication with a marking unit to generate variable data content and/or receive user input corresponding at least in part to the variable data content; receive instructions from the marking unit regarding a preferred routing of which of a plurality of communications interface modules on the marking unit to use for sending variable data content communications; update the machine-readable instructions to include the preferred routing; and communicate the variable data content to the marking unit using the preferred routing.

### BRIEF DESCRIPTION OF THE DRAWINGS

FIG. 1A is a high-level functional block diagram of an example of a marking unit designed to ablate variable data content onto product packaging, communicating with a global computer network via a plurality of network interfaces.

FIG. 1B is a high-level functional block diagram of the example of FIG. 1A, depicting the marking unit with a plurality of network interfaces, communicating with a global computer network via multiple intermediate networks.

FIG. 2 is a finite state diagram of a routing selection process the marking unit is able to perform in order to determine the most preferable way to transmit a given message.

FIG. 3 is a depiction of a lookup table (LUT) utilized by the marking unit to determine which physical gateway to utilize in order to transmit messages based upon the original sender, receiver, and Type-of-Service (TOS) of the message.

FIG. 4 is a workflow diagram depicting an exemplary marking unit communication interface selection method.

### DETAILED DESCRIPTION OF THE INVENTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical, optical, physical or electrical connection, link or the like by which signals produced or supplied by one system element are imparted to another coupled element. Unless described otherwise, coupled elements or devices are not necessarily directly connected to one another and may be separated by intermediate components, elements or communication media that may modify, manipulate or carry the signals.

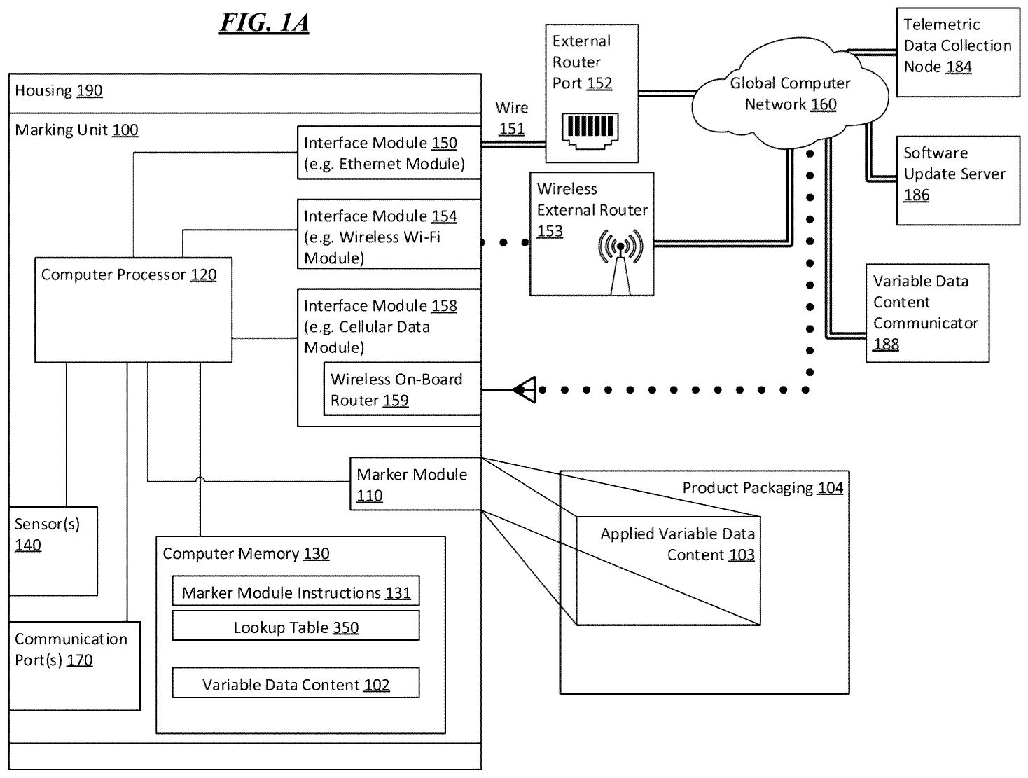

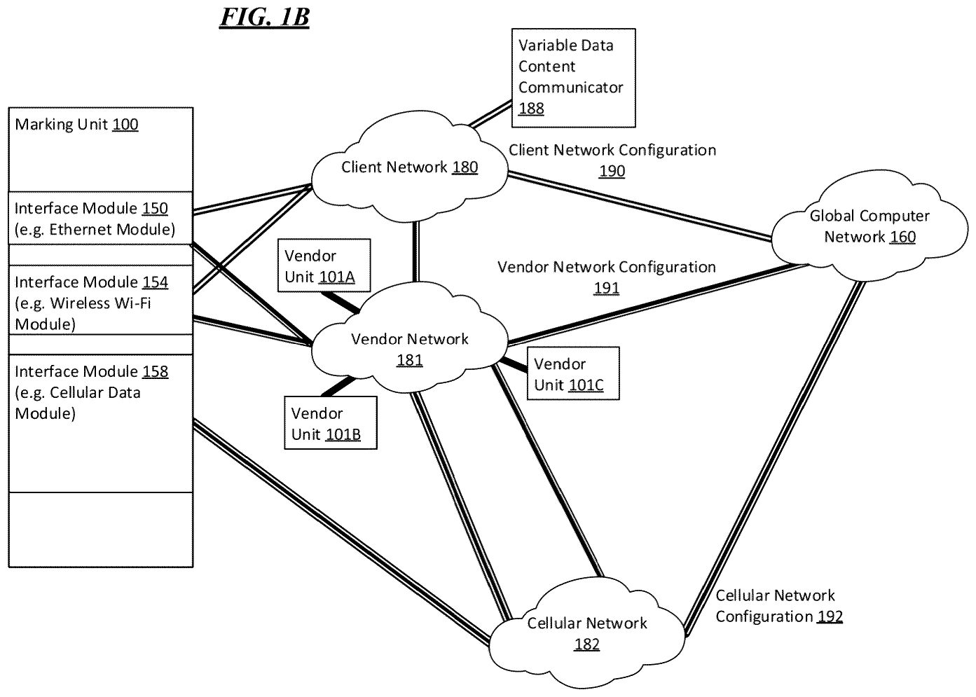

Referring now to FIG. 1A, there is shown a marking unit 100 configured for marking variable data content 102 on a product or product packaging 104. Marking unit 100 includes a marker module 110, at least one computer processor 120 connected to at least one computer memory 130, one or more sensors 140, and a plurality of interface modules 150, 154, and 158, and one or more communication ports 170. Housing 190 encloses at least some of the components, including in preferred embodiments, all of the plurality of interface modules 150, 154, 158, which may therefore be referred to as “on-board” modules. In other embodiments, one or more of the interface modules 150, 154, 158 may be external to the housing 190, and connected by wire or wirelessly to the marking unit 100.

Marker module 110 may be, without limitation, a laser marking module configured to ablate a surface the product or product packaging 104 in accordance with the variable data content 102 or a printer marking module, such as an inkjet printer (including a continuous inkjet or thermal inkjet printer) or a thermal transfer printer, configured to apply ink to a surface the product or product packaging 104 in accordance with the variable data content 102. Each of the one or more sensors 140 is configured to generate monitoring data relating to at least one operational variable of the marker module 110. One or more parameters corresponding to operational settings of the marker module 110 may also be included in the monitoring data.

As depicted, communications module 150 is a wired Ethernet connection module configured to connect via a wire 151 to a wire-receiving external router 152 port connected to the global computer network 160. Communications module 154 is a wireless Wi-Fi module 154 configured to connect wirelessly to a wireless external router 153 port connected to the global computer network 160. External router ports 152 and 153 may be embodied in the same router 155, or the ports may be embodied in different routers. Communications module 158 is a cellular data module configured to connect wirelessly directly to the global computer network 160 via an on-board router 159. The term “cellular data module” as used herein refers to any type of communications module compatible with any type of mobile communications technology employed by mobile phones, without limitation to any particular technology.

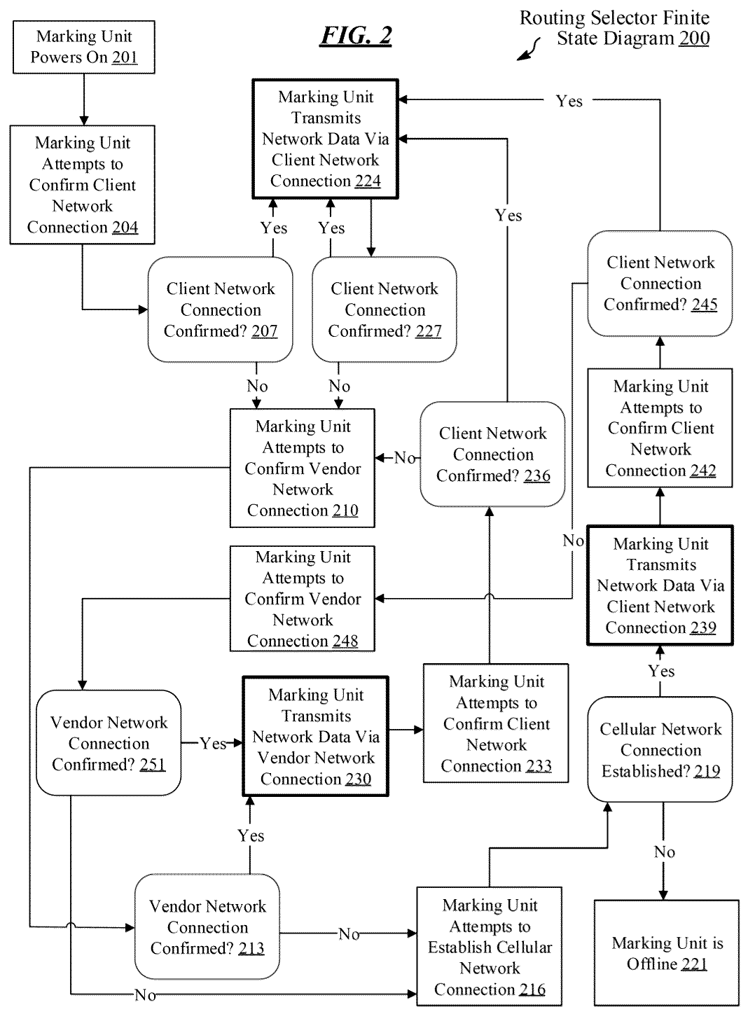

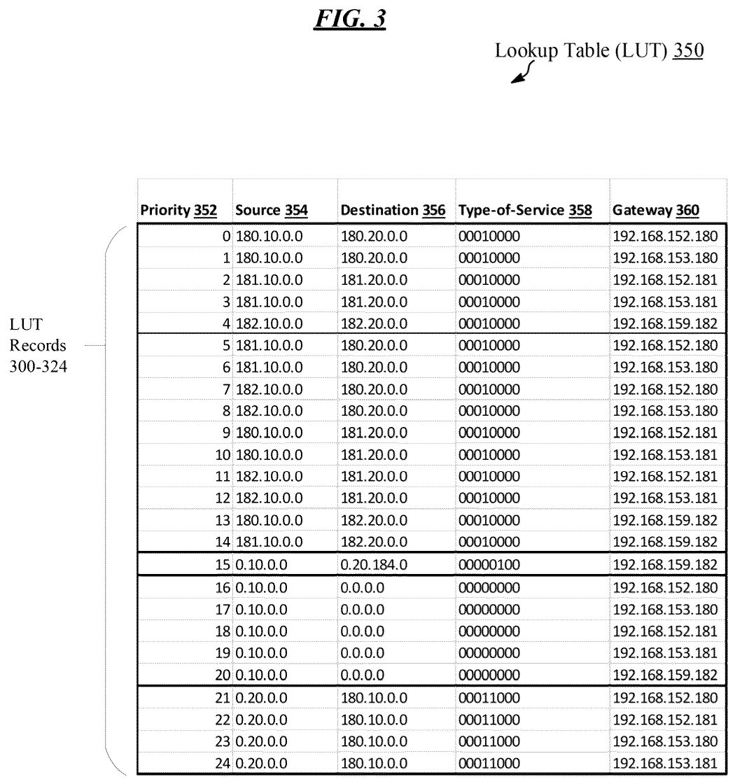

The machine-readable instructions executable by the computer processor 120 include marker module instructions 131 for causing the marker module 100 to apply the variable data content 102 to the product or product packaging 104 as applied variable data content 103, causing the computer processor 120 to generate telemetric data, causing communications to be sent or received, and selecting which of the plurality of interface modules 150, 154, 158 to use for sending or receiving each communication. The marker module instructions 131 include logic for selecting which interface module 150, 145, 158 to use based on the category of the communication and whether each of the plurality of interface modules 150, 154, 158 is available. This logic is disclosed by example in FIG. 2. The categories of communication include at least telemetric data/remote support communications, including sending telemetric data derived from the monitoring data over the global computer network 160 to a telemetric data collection/remote support node 184, sending and receiving remote service communications via the telemetric data collection/remote support node 184, including receiving predictions (e.g. for servicing) derived from predictive analysis. The categories of communication further include at least receiving software updates (i.e. 20) updates to the machine-readable instructions) from, e.g., a software update server 186, and receiving the variable data content from, e.g., a variable data content communicator 188, which may be a computer such as a personal computer, tablet computer, or mobile device connected to the network. Although shown communicating through the global computer network 160, in some embodiments, the variable data content 102 may communicated through a local network or a direct connection e.g. via the communication port(s) 170, or through the client network 181 or vendor network 182 via interface modules 150, 154, 158, without going through the global computer network 160. The computer memory 130 also may contain a lookup table (LUT) 350 (see FIG. 3) which describes either statically or algorithmically how the marking unit 100 should route or transmit messages.

FIG. 1B illustrates the various networks 180, 181, 182 and network configurations 190, 191, 192 the marking unit 100 may utilize in order to communicate with the global computer network 160. First, the marking unit 100 may use either the Ethernet interface module 150 or the Wi-Fi interface module 154 to connect to a client network 180. The client network 180 may be a Wi-Fi, Bluetooth, or other wireless network maintained on the premises of the client, for devices of the client to communicate with one another, as well as to communicate with a larger WAN or the internet. The client network 180 has a connection pathway (which pathway may be active or inactive at various times) out to the global computer network 160 such that the marking unit 100 can directly or indirectly communicate with the telemetric data collection/remote support node 184, the software update server 186, or the variable data content communicator 188, as well as other servers and nodes of the vendor. Variable data content communicator 188 preferably communicates over the client network directly 180 with client-controlled content creation or propagation machines.

In client network configuration 190, the marking unit 100 utilizes the client network 180 to directly connect to the global computer network 160. The marking unit 100 may require secure access to use the client network 180, and may be prohibited from contacting directly other marking units 100 or other devices of the vendor (shown as vendor units 101A-C) on the premises of the client. Vendor units 101A-C may be other marking units 100, or they may be other units serving the vendor, acting in such roles as interfaces for the client to upload variable data content 102, for the client to order or request service or maintenance, or acting as access terminals designed to connect other vendor units 101A-C and marking units 100 to the global computer network 160.

In vendor network configuration 191, the marking unit 100 utilizes the vendor network 181 to connect to the global computer network 160. The marking unit 100 may use either the Ethernet interface module 150 or the Wi-Fi interface module 154 to connect to the vendor network 181. The vendor network 181 is a wired or wireless network created by the vendor at the premises of the client. The vendor network 181, through one or more other networked units (such as the vendor units 101A-C), has a connection to the global computer network 160. The vendor network 181 may connect to the global computer network 160 via a gateway unit (e.g. vendor unit 101A), or another marking unit 100 (e.g. vendor units 101B-C) acting as a gateway: that gateway unit may have a direct wired or wireless network connection, such as via a cellular network 182 or a wired high-speed connection, to the global computer network 160. Alternatively, the gateway unit may have been given elevated permissions by the client to utilize a client network 180 that the marking unit 100 is not authorized to utilize: the client may implement this networking method to improve network simplicity: only requiring a client network 180 administrator to update networking rules for a single gateway unit, rather than updating multiple marking units 100 individually. Therefore, the vendor network 181 may directly connect to the global computer network 160, or may utilize the client network 180, or the cellular network 182 via another vendor unit 101A-C: the marking unit 100 connected to but not hosting the vendor network 181 is agnostic as to how the vendor network 181 ultimately reaches the global computer network 160.

In cellular network configuration 192, the marking unit 100 utilizes the cellular network 182 to connect to the global computer network 160. The marking unit 100 may use the cellular interface module 158 to connect to the cellular network 182. The cellular network 182 may be an LTE or other wireless broadband communication network. The cellular network 182 has a connection pathway (which pathway may be active or inactive at various times) out to the global computer network 160 such that the marking unit 100 can directly or indirectly communicate with the telemetric data collection/remote support node 184, the software update server 186, or the variable data content communicator 188, as well as other servers and nodes of the vendor. When in the cellular network configuration 192, the marking unit 100 may attempt to create a vendor network 181 itself, allowing other vendor units 101A-C to utilize the cellular network 182 via the vendor network 181 in order to access the global computer network 160.

The machine-readable instructions executable by the computer processor 120 including marker module instructions 131 for causing communications to be sent or received allow the marking unit 100 to work alone or in concert with the telemetric data collection node 184, software update server 186, variable data content 20) communicator 188, other vendor units 101A-C, or forwarding devices on the global computer network 160, client network 180, vendor network 181, or cellular network 182. When the marking unit 100 powers on, the marking unit 100 retrieves routing instructions, which may be the lookup table (LUT) 350 of FIG. 3, or a programmatic list of rules approximating the same functionality as the LUT 350. The LUT 350 instructions are typically set at the point of manufacture and not capable of being modified by the client or by the vendor, but the invention is not limited to any particular disposition of the LUT.

With respect to causing communications to be sent, the marking unit 100 determines which interfaces 150, 154, 158 are available, as well as which networks 180, 181, 182 are available to those interfaces 150, 154, 158. Based on this information and the instructions within the LUT 350, the marking unit 100 can cause communications to be sent over the proper interface 150, 154, 158 and network 180, 181, 182.

With respect to causing communications to be received, the marking unit 100, after determining which interfaces 150, 154, 158 are available, as well as which networks 180, 181, 182 are available to those interfaces 150, 154, 158, may message one or more devices on the networks 160, 180, 181, 182 to inform those devices to send or forward communication to a particular interface 150, 154, 158 over a particular network 180, 181, 182. The devices on the network 160, 180, 181, 182 may include telemetric data collection node 184, software update server 186, variable data content communicator 188, other vendor units 101A-C, or forwarding devices on the global computer network 160, client network 180, vendor network 181, or cellular network 182.

Alternatively, the telemetric data collection node 184, software update server 186, variable data content communicator 188, other vendor units 101A-C, or forwarding devices on the global computer network 160, client network 180, vendor network 181, or cellular network 182 may be configured to, upon a first communication in a set of communications, send a communication over all available networks 180, 181, 182 to all available interfaces 150, 154, 158. The marking unit 100 may only receive a subset of these, and further may reject all but one message, in order to indicate to the sender which network 180, 181, 182 and interface 150, 154, 158 is appropriate (e.g. the software update server 186 sends a communication over all networks 180, 181, 182 to all interfaces 150, 154, 158, and the marking unit 100 only receives communications over the cellular network 182 and the vendor network 181, at both the ethernet interface module 150 and the Wi-Fi interface module 154. The marking unit 100 rejects the communication from the cellular network 182, and the communication received at the Wi-Fi interface module 154. Consequently, the software update server 186 now is updated to transmit communications to the only interface with received and accepted a communication: the ethernet module 150 on the vendor network 181.)

Still further, other devices such as vendor units 101A-C or a client-controlled variable data content communicator 188 may be configured to expect the marking unit 100 to eventually join a network 180, 181, 182. Consequently, once the marking unit 100 powers on and connects to some intermediary networks 180, 181, 182 or the global computer network 160, dedicated software residing on those intermediary networks 180, 181, 182 or on the telemetric data collection node 184, software update server 186, variable data content communicator 188, other vendor units 101A-C, or forwarding devices on the global computer network 160, client network 180, vendor network 181, or cellular network 182 directs those respective components how to send a communication so that the marking unit may receive that communication.

Initialization of the marking unit may include the marking unit automatically determining which of the plurality of communications interface modules is available, including attempting to establish a connection to the telemetric data collection/remote support node automatically via the cellular data module. The marking unit may then look for and receive any available updates to the machine-readable instructions (e.g. preferably from the telemetric data collection/remote support node over the cellular data module). The marking unit may automatically select which of a plurality of communications interface modules to use for sending or receiving each communication; and automatically inform a sender configured to send communications to the marking unit as to the preferred routing of the plurality of communications. All of the foregoing automatic steps may occur without human intervention subsequent to connecting the marking unit to a source of power, as part of an initialization routine. Default instructions corresponding to the preferred routing may be pre-installed on the marking unit, but overrides may be programmable by a user, such as a user with access to an associated user interface. Modifications to the routing instructions may be made locally, or via a product support communication from the telemetric data collection/remote support node, or a combination thereof.

An exemplary routing selector finite state diagram 200 for an exemplary set of logical operations implemented by a marker module 100 is depicted in FIG. 2. In state 201, the marker module 100 is powered on at a client site. The marker module 100 may have been delivered, or personally installed by a technician sent by the vendor of the marker module 100. In embodiments, the marker module 100 May include a battery unit, and the interface modules 150, 154, 158 may be active at any point from manufacture until installation. In such an example, the marking unit 100 may cycle through the routing selector finite state diagram 200, attempting to connect to the global computer network 160, or alternatively the marking unit 100 may wait for a signal to attempt the logical operations implemented in the routing selector finite state diagram 200. Installation may be as simple as plugging the marking unit 100 into an electrical outlet.

Once the marking unit 100 is powered on and moving though the routing selector finite state diagram 200, in state 204 the marking unit 100 attempts to confirm an active connection to the client network 180. The client network 180 can be a Wi-Fi or Bluetooth network maintained on the premises of the client, for devices of the client to communicate with one another, as well as a larger WAN or the internet. The client network 180 has a connection pathway (which pathway may be active or inactive at various times) out to the global computer network 160 such that the marking unit 100 can directly or indirectly communicate with the telemetric data collection/remote support node 184, the software update server 186, or the variable data content communicator 188, as well as other servers and nodes of the vendor. The connection to the client network 180 may be made via the external router port 152 of the interface module 150, the external wireless router 153 of the interface module 154, or one or more communication ports 170 of the marking unit 100.

In state 207, the marking unit 100 acts upon the result of confirming that the marking unit 100 has an active connection to the client network 180, and that via the client network 180, the marking unit 100 has an active connection to the global computer network 160. If the marking unit 100 has such an active connection to the client network 180, then the marking unit can proceed to state 224, where the marking unit 100, utilizing the client network 180, is able to communicate with the telemetric data collection/remote support node 184, the software update server 186, or the variable data content communicator 188, as well as other servers and nodes of the vendor, via the global computer network 160. Once the marking computer 100 completes the communication in state 224, and the marking unit 100 needs to engage in additional communication, the marking unit 100 enters state 227, where again the marking unit 100 confirms an active connection to the client network 180. If the marking unit 100 has confirmed the active connection to the global computer network 160 via the client network 180, then the marking unit 100 returns to state 224 and performs additional communication. While the marking unit 100 has an active connection to the global computer network 160 via the client network 180, the marking unit 100 will cycle between state 224 and state 227 when the marking unit 20) communicates with the global computer network 160.

Confirming an active connection (as in states 207, 213, 219, 227, 236, 245, 251) can also require determining if a particular connection is appropriate for a particular type of data: for example, telemetric data and remote support communications to/from the telemetric data collection/remote support node 184 May be set to always utilize the cellular network 182, whereas the remaining data may use the most efficient, available active network 180, 181, 182. Alternatively, perhaps for security reasons, the vendor or client may decide that variable data content 102 from the variable data content communicator 188 must not travel over the cellular network 182, and therefore may be limited to the client network 180 or the vendor network 181. If a particular connection is inappropriate for a particular type of data or message, the connection is not confirmed.

If, while the marking unit 100 is in either state 207 or 227, the marking unit 100 is unable to confirm an active connection to the client network 180, or the connection to the client network 180 does not allow a connection out to the global computer network 160, the marking unit 100 proceeds to state 210. In state 210, the marking unit 210 attempts to confirm an active connection to the vendor network 181. The vendor network 181 is a wired or wireless network created by the vendor at the premises of the client. The vendor network 181, through one or more other networked units, has a connection pathway to the global computer network 160. The vendor network 181 may connect to the global computer network 160 via a gateway unit, or another marking unit 100 acting as a gateway: that gateway unit may have a direct wired or wireless network, such as via a cellular network 182 or a wired high-speed connection, to the global computer network 160. Alternatively, the gateway unit may have been given elevated permissions by the client to utilize a client network 180 that the marking unit 100 is not authorized to utilized: the client may implement this method to improve network simplicity, and to only require that a client network 180 administrator update networking rules for a single gateway unit, rather than multiple marking units 100 individually. The connection to the vendor network 181 may be made via the external router port 152 of the interface module 150, the external wireless router 153 of the interface module 154, or one or more communication ports 170 of the marking unit 100. The data type check can be performed at any time as the marking unit 100 proceeds through the routing selector finite state diagram 200.

In state 213, the marking unit 100 acts upon the result of confirming that the marking unit 100 has an active connection to the vendor network 181, and that via the vendor network 181, the marking unit 100 has an active connection to the global computer network 160. If the marking unit 100 has such an active connection to the vendor network 181, then the marking unit can proceed to state 230, where the marking unit 100, utilizing the vendor network 181, is able to communicate with the telemetric data collection/remote support node 184, the software update server 186, or the variable data content communicator 188, as well as other servers and nodes of the vendor, via the global computer network 160. Once the marking computer 100 completes the communication in state 230, and the marking unit 100 needs to engage in additional communication, the marking unit 100 enters state 233.

In state 233, the marking unit 100 attempts to confirm an active connection to the client network 180. The marking unit 100 attempts to confirm an active connection to the client network 180, and not the vendor network 181 at this time because the client network 180, when available, is the preferred connection for the marking unit 100 to utilize. Via configurations, checking the client network 180 can be omitted if the vendor either chooses to not use a client network 180, or the vendor is reasonably certain that a client network 180 is not available. Omitting the client network 180 check can be set as a flag (e.g. boolean OMIT_CLIENT_NETWORK_CHECK=1), or the marking unit 100 may be deployed with firmware which does not implement any of and thereby skips over the functions in the routing selector finite state diagram 200 related to the client network 180.

In state 236 the marking unit 100 acts upon the result of confirming that the marking unit 100 has an active connection to the client network 180, and that via the client network 180 the marking unit 100 has an active connection to the global computer network 160. If the marking unit 100 has such an active connection to the client network 180, then the marking unit can proceed to state 224. If the marking unit 100 does not have such an active connection to the client network 180, then the marking unit returns to state 210 where the marking unit 100 attempts to confirm an active connection to the vendor network 181.

Returning to state 213, should the marking unit 100 determine that the marking unit 100 does not have an active connection to the vendor network 181, then the marking unit 100 will attempt to confirm an active connection to a cellular network 182. The cellular network 182 may be an LTE or other wireless broadband communication network. The cellular network 182 has a connection pathway out to the global computer network 160 such that the marking unit 100 can directly or indirectly communicate with the telemetric data collection/remote support node 184, the software update server 186, or the variable data content communicator 188, as well as other servers and nodes of the vendor. The connection to the cellular network 182 may be made via the wireless on-board router 159 of the interface module 158, or one or more communication ports 170 of the marking unit 100.

In state 219, the marking unit 100 acts upon the result of confirming that the marking unit 100 has an active connection to the cellular network 182, and that via the cellular network 182, the marking unit 100 has an active connection to the global computer network 160. If the marking unit 100 has such an active connection to the cellular network 182, then the marking unit can proceed to state 239, where the marking unit 100, utilizing the cellular network 182, is able to communicate with the telemetric data collection/remote support node 184, the software update server 186, or the variable data content communicator 188, as well as other servers and nodes of the vendor, via the global computer network 160. Other marking units 100, via the vendor network 181, may utilize the cellular connection of this marking unit 100 to communicate with the global computer network 160.

If the marking unit 100 cannot connect to the global computer network 160 via the cellular network 182, then the marking unit 100 enters state 221 and is offline. The marker unit 100 has attempted to utilize the client network 180, the vendor network 181, and the cellular network 182 to reach the global computer network 160, without success. In this state, the marker unit 100 may use an audio or visual signal (such as a tone or a flashing light) to indicate the lack of network connectivity to nearby person; may enter an inactive state; may power off; or may return to state 204, possibly after a time delay. Any conventional behaviors implemented by a device with an offline network status are contemplated.

Returning to state 239, once the marking unit 100 completes the communication in state 239, and the marking unit 100 needs to engage in additional communication, the marking unit 100 enters state 242, where again the marking unit 100 confirms an active connection to the client network 180. If the marking unit 100 has confirmed the active connection to the global computer network 160 via the client network 180 in state 245, then the marking unit 100 returns to state 225 and performs additional communication. The marking unit 100 attempts to confirm an active connection to the client network 180, and not the vendor network 181 or the cellular network 182 at this time because the client network 180 when available is the preferred connection for the marking unit 100 to utilize.

However, if in state 245 the marking unit 100 is unable to confirm an active connection to the client network 180, then the marking computer 100 enters state 248, and attempts to confirm an active connection to the vendor network 181. The marking unit 100 attempts to confirm an active connection to the vendor network 181, and not the cellular network 182, at this time because the vendor network 181 when available (and when the client network 180 is not available) is the preferred connection for the marking unit 100 to utilize.

In state 251, the marking unit 100 acts upon the result of confirming that the marking unit 100 has an active connection to the vendor network 181 in state 248, and that via the vendor network 181, the marking unit 100 has an active connection to the global computer network 160. If the marking unit 100 has such an active connection to the vendor network 181, then the marking unit 100 can proceed to state 230. If the marking unit 100 does not have such an active connection to the vendor network 181, then the marking unit proceeds back to state 216.

The routing selector finite state diagram 200 presumes that the preferred order of network selection is: first, client network 180; second, vendor network 181; and third, cellular network 182. Other implementations may presume other orderings. For example, perhaps the vendor prefers the vendor network 181, connected to the global computing network via the cellular network 182. This allows the vendor full control over the data flow to and from the marking unit 100, while still minimizing cellular data expenses. However, if cellular data is not available to any marking unit 100 on the client premises, or there is too much broadcast interference to establish a vendor network 181, the vendor may prefer to be able to fall back on the client 35 network 180. In such an example, the preferred order of network selection would be: first, vendor network 181; second, cellular network 182; third, client network 180. Still further, the vendor may prefer the marking units 100 on the client premises to communicate with each other over the vendor network 181, but still preferably use the client network 180 for aggregated messaging to the global computer network 160. There, the preferred order of network selection would be: first, vendor network 181; second, client network 180; and third, cellular network 182. Yet further, the vendor may prefer to not increase Wi-Fi traffic and interference within the premises of the client; should Wi-Fi traffic be necessary, the vendor may prefer the traffic moves over the client network 182 so that the client is aware of the sources of Wi-Fi traffic or interference. In such an example, the preferred order of network selection would be: first, cellular network 182; second, client network 180; and third, vendor network 181. Therefore, despite FIG. 2 disclosing a particular routing selector finite state diagram 200, the priority of networks 180, 181, 182 may be adapted to the needs of the vendor or the client, and may be established at the time of installation, or may be determined and changed as-needed: by the client, the vendor, or an algorithmic network traffic routing process. There may also be separate routing table finite state diagrams 200 for any combination of data or message senders, receivers, and message or data types—the appropriate routing table finite state diagram 200 is selected once the marking unit 100 knows what kind of message or data the marking unit is sending, and what other networked device is receiving the message or data.

In preferred embodiments, the marking unit 100 may be configured to send and receive communications over two or more of the plurality of interface 150, 154, 158 modules simultaneously. For example, the marking unit 100 may be configured to transmit telemetric data over the cellular module 158 while also receiving variable data content via the Wi-Fi module 150 or the Ethernet module 154. As a practical matter, software update information may be downloadable at any time, but for various operational reasons, it may be necessary to delay updating the software until a time when the marking unit 100 is not actively marking product via the marking module 110. Accordingly, a software update file may be stored in the computer memory 130, and the computer processor 120 may send a prompt to a user interface seeking authorization to install or a designated date/time when the installation may be executed. The cellular communication module 158 may be configured to receive data and send data simultaneously, but in other embodiments, the computer processor 120 may be configured to spool (save) telemetric data into the computer memory 130 while incoming information is being received via the cellular module 158. The telemetric data may be spooled routinely, to limit the number of communications sent with telemetric data, and/or the telemetric data may be spooled on an as-needed basis. For example, data may be sent periodically (e.g. hourly, daily) in bursts rather than having a continuous feed, which may minimize communication charges, or data may be spooled at a time when the cellular connection is disabled, rather than using a different communication mode.

Sensor data to or from the sensor(s) 140 may be sent in raw form via the communication modules 150, 154, 158, or it may be processed before sending. For example, sensor data may be collected continuously by the computer processor 120 in one form and converted from the signal as received to a different metric. Thus, the telemetric data may be derived from the sensor data, but may not be identical to the sensor data. For example, data may be averaged over a designated period of time. Sensor data may be sent at one frequency when the data is in an expected range or within an expected amount of fluctuation or deviation, and at a second frequency when the data is out of range or fluctuating abnormally. Additionally, the telemetric data may include monitoring data in the nature of parameter settings for the marker module, which settings may be stored in memory and programmable using a user interface.

The logic for routing data may be provided in the form of a lookup table (LUT) 300, such as that depicted in FIG. 3. The depicted LUT 350 allows the markup unit 100 to return non-local traffic on the same interface 150, 154, 158 where the traffic was received. The LUT 350 also allows the markup unit 100 to select a particular interface 150, 154, 158 for specific data flows, rather than sending all traffic through a single interface 150, 154, 158. Further, the LUT 350 allows the marking unit 100 to switch back and forth between different routing policy scenarios based on connectivity status to a cellular network 182, vendor network 181, or client network 180, as well as based on vendor or client decisions. The LUT 350 assists in the marking unit 100 fulfilling these requirements. The LUT 350 implements a strong host model, meaning that both the source of a message as well as the destination of a message are relevant in selecting the network 180, 181, 182 as well as network interface 150, 154, 158 used to transmit a message.

The LUT 350 depicted has a priority column 352: when the marking unit 100 needs to send a message, the marking unit 100 will select the LUT 350 record 300-324 with the highest priority. The LUT 350 records 300-324 also have a source IP address 354: this source IP address 354 indicates where the message is originating from, and potentially which interface module 150, 154, 158 the marking unit 100 would prefer to transmit with. For the purposes of this example, a 180.0.0.0 address is the address for any vendor unit, node, server, or communicator connected via the client network 182; a 181.0.0.0 address is the address for any vendor unit connected via the vendor network 181; and the 182.0.0.0 address is the address for any vendor unit connected via the cellular network 182. Vendor units may be connected via multiple network 180, 181, 182. 0.10.0.0 is the address range for any vendor unit at the premises of the client. 0.10.100.0 is the address range for the marking unit 100.

The LUT 350 further has a destination IP address column 356: this destination IP address 356 indicates where the message is to be sent. Again, for the purposes of this example, 180.0.0.0 address is the address range for any vendor unit connected via the client network 180; a 181.0.0.0 address range includes the address for any vendor unit connected via the vendor network 181; and the 182.0.0.0 range address is the address for any vendor unit connected via the cellular network 182. 0.20.0.0 is the address range for any vendor unit at the premises of the vendor; and 0.20.184.1 indicates the telemetric data collection/remote support node 184, in particular a port of the telemetric data collection/remote support node 184 designated for incoming telemetric data.

Still further, the LUT 350 has a Type-of-Service (TOS) column 358: this TOS 358 indicates the type of message being sent, and conventionally is a bit-array that is byte-sized. For the purposes of this example, a 00010000 TOS type 358 is an acknowledgement or a response; a 00000100 TOS type 358 is a transmittal of outgoing telemetric data; a 00000000 TOS type 358 is a non-specific type; and a 00011000 TOS type 358 is a transmittal of incoming variable data content 102.

Continuing, the LUT 350 has a gateway column 360: the gateway 360 indicates which physical apparatus 152, 153, 159 of the markup unit 100 will actually transmit the message, assuming the physical apparatus 152, 153, 159 is operable and connected to a network 180, 181, 182. For the purposes of this example, address range 192.168.152.0 is the external router port 152 of the Ethernet interface module 150; address range 192.168.153.0 is the wireless external router 153 of the Wi-Fi 25 interface module 154; and address range 192.168.159.0 is the wireless on-board router 159 of the cellular interface module 158.

The LUT 350 depicted is designed to implement five rules: First, any message received from a vendor device located on vendor premises should be preferably responded to by the marking unit 100 on that same network 180, 181, 182 where it was received. Second, outgoing telemetric data intended for the port designated for incoming telemetric data of the telemetric data collection/remote support node 184 may only be sent via the cellular interface module 158 over the cellular network 182 (and likewise return communications from the support telemetric data collection/remote support node 184 are also sent via the cellular interface module 158 over the cellular network 182). Third, for non-specific typed messages, the message should preferably be sent over the client network 180, the vendor network 181, or the cellular network 182, in that order. Fourth, incoming variable data content 102 should preferably be transmitted over ethernet when available, rather than wireless: cellular is not permitted. Fifth, when using the client network 180 or the vendor network 181, the Ethernet interface module 150 is preferred over the Wi-Fi interface module 154.

LUT records 300-314 implement the first rule; LUT record 315 implement the second rule; LUT records 316-320 implement the third rule; LUT records 321-324 implement the fourth rule; and LUT records 300-303, 305-312, 316-319, 321-324 implement the fifth rule.

In a first example, the marking unit 100 has received a message from the software update server 186 over the vendor network 181. The software update server 186 is not able to communicate over the client network 180, but can communicate over the vendor network 181 and the cellular network 182. The marking unit 100 can communicate over any network 180, 181, 182; and any interface module 150, 154, 158. The marking unit 100 needs to acknowledge the message from the software update server 186, which means the message from the marking unit 100 will have a TOS of 00010000. Because the TOS is 00010000, the marking unit 100 will need to use a LUT record 300-314, where the TOS 358 value matches 00010000. Next, because the marking unit 100 is configured to respond on the same network 180, 181, 182 as the sender, the marking unit 100 will try to use a source address in the 181.0.0.0 range, to match the sender which used the vendor network 181 in the 181.0.0.0 address range. The LUT records 302, 303, 309-312 which conform to all requirements so far described are where the source 354 is within the address range 181.0.0.0, and the TOS 358 is 0001000. Finally, of the remaining LUT records 302, 303, 309-312, the marking unit 100 selects the highest priority 352 LUT record 302, which represents the desire of the marking unit 100 to respond on the same network 181 as the original message was sent over, preferably via Ethernet. The marking unit 100 then sends the acknowledgement message to the software update server 186 at the address 181.20.186.0, via the ethernet module 150 with the gateway address 192.168.152.181.

In a second example, the marking unit needs to transmit outgoing telemetric data to the telemetric data collection/remote support node 184. The marking unit 100 can communicate over any network 180, 181, 182; and any interface module 150, 154, 158. The marking unit 100 is sending outgoing telemetric data, which means the message from the marking unit will have a TOS of 00000100. Because the TOS is 00000100, the marking unit 100 will need to use LUT record 315, where the TOS 358 value matches 00000100. Therefore, the marking unit 100 selects the only LUT record 315 available, and sends the message over the cellular network 182, from the address 182.10.100.0, via the cellular module 158 with the gateway address 192.168.159.182.

In a third example, the marking unit 100 needs to respond to a network heartbeat message sent by another vendor unit 101C over the cellular network. The heartbeat message has a TOS 358 of 00000000, and both the vendor unit 101C and the marking unit 100 can communicate over all networks 180, 181, 182; however, neither the vendor unit 101C and the marking unit 100 have a connected ethernet module 150. The IP address range for the vendor unit 101C is 0.10.101.0. Because the heartbeat message is a non-specific type of message, it has a TOS 358 of 00000000. Therefore, the LUT records 316-320 are the range of records to pursue. Because the vendor address of 0.10.101.0 is within 0.0.0.0, and the marking unit 100 address of 0.10.100.0 is within 0.10.0.0, any of the LUT records 316-320 could be used. However, because the marking unit 100 is lacking an ethernet connection to any network 180, 181, only the LUT records 317, 319-20 utilizing the wireless connection or cellular network could be used. The highest priority remaining LUT record 317 is selected, and the marking unit 100 responds to the heartbeat message at the vendor unit 101C address of 180.10.101.0 via the gateway address 192.168.153.180.

In a fourth example, the marking unit 100 needs to route variable data content 102 to the vendor unit 101C from the prior example. The variable data content 102 has a TOS 358 of 00011000, and so the LUT records 321-324 are the relevant records in the LUT table 300. The marking unit 100 is still lacking an ethernet interface module 150 connection, and so the marking unit 100 cannot select the first two otherwise-eligible LUT records 321-322. Therefore, the marking unit 100 selects the next available LUT record 323, and transmits the variable data content 102 to the vendor unit 101C at the same vendor unit 101C address of 180.10.101.0 via the same gateway address 192.168.153.180.

While certain exemplary options are depicted in the LUT table 350, it should be understood that table is intended to be non-limiting. The invention is not limited only to the set of options listed in the LUT table 350, nor to the designations shown for each option. However, cellular communications over the cellular network 182 are preferred for telemetric and software download transmissions as a general rule, because this type of communications protocol avoids using resources of the installation location, and relies solely upon the resources provided in the marking unit 100. Each manufacturing location may have a different set of rules that require a different set of logical determinations. The logic outcomes may be programmable via a user interface locally or remotely, at the time of installation or after installation, and/or may be factory programmed with default or bespoke settings.

The LUT table 350 and the route selector finite state diagram 200 can be used in conjunction. First, the LUT table 350 determines the priority of the networks 180, 181, 182 for the given type of message, sender, and receiver. Then, the route selector finite state diagram 200 is reordered to accommodate that priority. The default priority is first the client network 180, then the vendor network 181, then the cellular network 182: this order can be changed based on the needs of the message. Next, the route selector finite state diagram 200 is traversed, until one of the states 224, 230, 239 which allows for message sending is reached. Continuing, presuming the state 224, 230, 239 is permitted by the LUT table 350, the message is sent by the marking unit 100. Otherwise, the marking unit 100 continues traversing the finite state diagram 200 until a messaging state 224, 230, 239 is reached that can satisfy the LUT table 350 for this particular message. This logic results in the policy rules and routing tables that together implement the necessary traffic scenarios, and also monitors the networking status on the various interfaces 150, 154, 158 of the marking unit 100 as well as user decisions in order to dynamically switch from one traffic scenario to another.

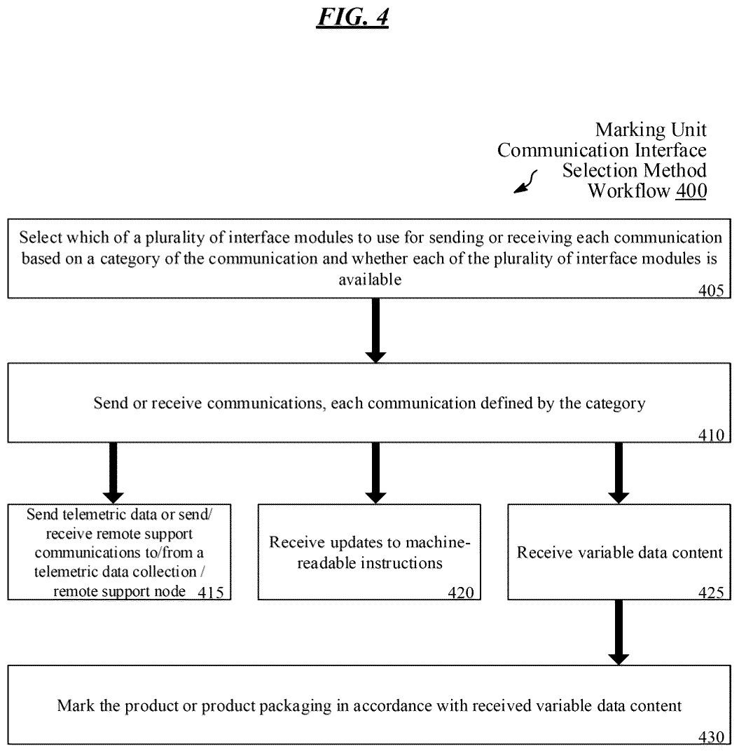

FIG. 4 depicts an exemplary marking unit communication interface selection method workflow 400. This workflow describes a method by which a marking unit 100 selects which interface 150, 154, 158 the marking unit 100 should utilize for a particular network communication (e.g. based on TOS 358). First, in step 405, the method 400 includes selecting which of a plurality of interface modules 150, 154, 158 to use for sending or receiving a communication based on the category or TOS 358 of the communication and whether each of the plurality of interface modules 150, 154, 158 is available. The categories include but are not limited to: telemetric data, updates to machine-readable instructions, and variable data content.

In some embodiments, an interface module 150, 154, 158 is considered “available” if it has an active connection to an internet (e.g. global computer network 160) and a marking unit 100 has permission to use that interface module 150, 154, 158. Selecting which of the plurality of interface modules 150, 154, 158 to use may comprise preferential selection of a cellular data module 158 for sending the telemetric data, sending/receiving support communications, and for receiving updates to the machine-readable instructions. Additionally, selecting which of the plurality of interface modules 150, 154, 158 to use may comprise preferential selection of one of the interface modules 150, 154 other than a cellular data module 158 for receiving the variable data content 102.

Continuing into step 410, the method 400 includes sending or receiving communications, each communication defined by the category of the communication. In some examples, sending or receiving communications comprises sending and receiving communications over two or more of the plurality of interface modules 150, 154, 158 simultaneously. The method 400 may include selecting which network 180 181, 182 to utilize to reach the internet (e.g. global computer network 160).

Step 415 of the method 400 includes sending telemetric data over a global computer network 160 (e.g. internet) to a telemetric data collection/remote support node 184 or sending/receiving remote support communications, which occurs when the category is telemetric data or remote support communications. Step 420 of the method includes receiving updates to machine-readable instructions (e.g. marker module instructions 131), which occurs when the category is updates to machine-readable instructions. Step 425 of the method includes receiving variable data content 102, which occurs when the category is variable data content 102.

In step 430, if variable data content 102 was received, then the method 400 includes marking the product or product packaging 104 in accordance with received variable data content 102. In some embodiments, applying the variable data content 103 includes marking the product or product packaging by ablating a surface via laser of the product or product packaging in accordance with the variable data content. In other embodiments, applying the variable data content 103 includes marking the product or product packaging by applying ink to a surface of the product or product packaging in accordance with the variable data content.

An exemplary printing system utilizing the above-described networking technology experienced no CPU or memory concerns, and experienced no missed prints through the system during a two-week trial. Improved connectivity allows for reliable real-time visibility to dashboards and alerts, which may reduce a need for reprints by a factor of thirty relative to an unconnected or unreliably connected system. Robust connections allow for remote support, allowing users to receive immediate troubleshooting and repair help, as well as rapid recovery, where users receive guidance on whether to repair or swap to another marking unit in order to recover the printing line of the user faster. The analytics based upon the data captured by the marking unit 100 and sent to the telemetric data collection/remote support node 184 may provide historical results across an entire manufacturing location of a user, reducing line stops down to 0.6 stops per machine per week, as well as insight into data via analysis and reporting for advanced operations optimization.

Although examples are described herein, the type of marking unit 100, or the types of laser marking or printing marking modules are not limited to any particular type of unit. Exemplary data to be monitored by the sensors and parameters transmitted telemetrically are discussed in U.S. Pat. No. 9,524,132, incorporated by reference, but the types of sensors and types of data to be monitored are not limited in any way. Data monitored and transmitted telemetrically not only includes telemetric data collected by sensors and status information generated by processing unit 120 (e.g. faults, warnings, parameter changes, etc.), but also includes remote support communications, including service communications based on predictive results, which may be sent from the telemetric data collection/remote support node 184 to the marking unit 100.

Any of the steps or functionality of the routing selector finite state diagram 200, marker module instructions 131, LUT 350, or marking unit communication interface selection method workflow described herein for the marker unit 100 can be embodied in programming or one more applications as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++), procedural programming languages (e.g., C or assembly language), or firmware. In a specific example, a third-party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or other mobile operating systems. In this example, the third-party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution. Such media may reside in any one of the components as discussed herein and accessible by a respective processor for causing that process to execute the instructions stored thereon. The media may also reside on a server, including a server configured to transmit software and/or firmware updates to the respective local memory media locations. Accordingly, any of the method steps as described herein and capable of being performed by a processor may be the subject of a specially programmed device including a processor and programmed instructions stored in computer memory and accessible by the processor for causing the processor to execute the method steps.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims. It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts. To the extent that the following claims expressed as dependent claims may recite only a single preceding independent or dependent claim rather than being expressed in multiple dependent claim format, it should be understood that any of the features set forth therein may be combined with any other features described and/or claimed herein that are not mutually exclusive therewith, in any combination or permutation, and that embodiments of the invention may be expressed in multiple dependent claim format, including multiple dependent claims that depend form other multiple dependent claims in national jurisdictions that permit the same, without limitation.

Although the invention is illustrated and described herein with reference to specific embodiments, the invention is not intended to be limited to the details shown. Rather, various modifications may be made in the details within the scope and range of equivalents of the claims and without departing from the invention.

1. A marking unit configured for marking variable data content on a product or product packaging, the marking unit comprising:
a marker module configured to mark the product or product packaging in accordance with the variable data content;
at least one computer processor connected to at least one computer memory and the marker module, the computer memory comprising machine-readable instructions for causing the marker module to mark the variable data content on the product or product packaging;
one or more sensors, connected to the computer processor and/or the computer memory, each sensor configured to generate monitoring data relating to at least one operational variable of marker module, wherein the machine-readable instructions including instructions for causing the at least one computer processor to generate telemetric data corresponding at least in part to the monitoring data;
a plurality of interface modules comprising:
a wired Ethernet connection module configured to connect via a wire to an external router;
a wireless WI-FI module configured to connect wirelessly to an external router; and
a cellular data module;
one or more communication ports connected to the at least one computer processor and at least one of the plurality of interface modules, wherein the machine-readable instructions executable by the at least one computer processor include instructions for:
a) sending or receiving communications, including communications defined by a category of communication selected from the group consisting of:
i. sending the telemetric data to a telemetric data collection/remote support node;
ii. receiving remote support communications from the telemetric data collection/remote support node;
iii. receiving updates to the machine-readable instructions;
iv. receiving the variable data content;
b) selecting which of the plurality of interface modules to use for sending or receiving each communication based on the category of communication and whether each of the plurality of interface modules is available.

2. (canceled)

3. The marking unit of claim 1, wherein the instructions for selecting which of the plurality of interface modules to use comprises logic configured to cause preferential selection of:
the cellular data module for sending the telemetric data and for receiving updates to the machine-readable instructions;
one of the interface modules other than the cellular data module for receiving the variable data content; or
a combination thereof.

4. (canceled)

5. The marking unit of claim 1, wherein the marking unit is configured to send and receive communications over two or more of the plurality of interface modules simultaneously.

6. The marking unit of claim 1, wherein the marking unit includes a housing, and the plurality of interface modules are on-board modules contained within the housing.

7. The marking unit of claim 1, wherein the monitoring data also includes one or more parameter settings corresponding to the marking module.

8. The marking unit of claim 1, wherein the marker module comprises:
a laser marking module configured to ablate a surface of the product or product packaging in accordance with the variable data content, or
a printer marking module configured to apply ink to a surface of the product or product packaging in accordance with the variable data content, the printer marking module optionally selected from the group consisting of: an inkjet printer, a continuous inkjet printer, a thermal inkjet printer, and a thermal transfer printer.

9-13. (canceled)

14. A method for marking variable data content with a marking unit on a product or product packaging, the marking unit having a processor programmed with machine-readable instructions and a plurality of communications interface modules, the method comprising:
the marking unit sending or receiving one or more communications via one or more of the plurality of communications interface modules, each of the one or more communications defined by a category selected from the group consisting of:
a) sending telemetric data to a telemetric data collection/remote support node,
b) receiving remote support communications from the telemetric data collection/remote support node;
b) receiving updates to the machine-readable instructions, and
c) receiving variable data content;
the marking unit determining which of the plurality of communications interface modules is available;
the marking unit selecting which of a plurality of communications interface modules to use for sending or receiving each communication based on the category of the communication and the determination as to which of the plurality of communications interface modules is available; and
the marking unit receiving the variable data content and marking the product or product packaging in accordance with received variable data content.

15. The method of claim 14, wherein one or more of the plurality of communications interface modules is considered available if it has an active connection to a message destination address connected to a network and the marking unit has permission to use that communications interface module.

16-21. (canceled)

22. The method of claim 14, further comprising receiving and processing the telemetric data with a remote processor, identifying a remote support communication for the marking unit based at least in part upon the telemetric data, and sending the remote support communication to the marking unit via the telemetric data collection/remote support node.

23. The method of claim 22, wherein processing the telemetric data comprises performing predictive analysis, and the remote support communication comprises a service communication based upon the predictive analysis of the telemetric data.

24. The method of claim 14, further comprising receiving an update to the machine-readable instructions, storing the machine-readable instructions in a computer memory associated with the processor of the marking unit, and updating the machine-readable instructions at a time when the marking unit is not actively engaged in a marking operation.

25. (canceled)

26. The method of claim 24, wherein the processor of the marking unit prompts a user via a user interface associated with the marking unit for authorization and/or a designated date/time to perform the updating of the machine-readable instructions.

27. The method of claim 14, further comprising receiving an incoming communication and sending an outgoing communication simultaneously over a cellular data module, or spooling telemetric data to a computer memory associated with the marking unit while an incoming communication is being received via a cellular data module, and then sending the spooled telemetric data after termination of the incoming communication.

28. (canceled)

29. The method of claim 14, further comprising the marking unit informing a sender configured to send communications to the marking unit as to a preferred routing of the plurality of communications interface modules to send the communications, wherein at least one of:
(a) the preferred routing includes identifying at least a first one of the plurality of communications interface modules as a primary route and identifying at least a second one of the plurality of communications interface modules as a secondary route for use when the primary route is unavailable;
(b) the step of informing the device comprises rejecting at least one communications sent by the device to each of the plurality of communications interface modules that are not in the preferred routing; and
(c) the step of informing the device comprises sending at least one communication to the device via the preferred routing.

30-32. (canceled)

33. The method of claim 29, further comprising storing instructions corresponding to the preferred routing in computer memory connected to a device associated with the sender.

34. The method of claim 29, further comprising initializing the marking unit, the initializing comprising:
automatically determining which of the plurality of communications interface modules is available, including attempting to automatically establish a connection to the telemetric data collection/remote support node via the cellular data module;
automatically receiving any available updates to the machine-readable instructions;
automatically selecting which of a plurality of communications interface modules to use for sending or receiving each communication; and
automatically informing the sender configured to send communications to the marking unit as to the preferred routing of the plurality of communications.

35. The method of claim 34, wherein the initializing the marking unit is performed without human interaction subsequent to the marking unit being connected to a power source.

36. A system for marking variable data content on a product or product packaging, the system comprising:
a marking unit comprising:
a marker module configured to mark the product or product packaging in accordance with the variable data content;
at least one computer processor connected to at least one computer memory and the marker module, the computer memory comprising machine-readable instructions for causing the marker module to mark the variable data content on the product or product packaging;
one or more sensors, connected to the computer processor and/or the computer memory, each sensor configured to generate monitoring data relating to at least one operational variable of marker module, wherein the machine-readable instructions including instructions for causing the at least one computer processor to generate telemetric data corresponding at least in part to the monitoring data;
a plurality of interface modules comprising:
a wired Ethernet connection module configured to connect via a wire to an external router;
a wireless WI-FI module configured to connect wirelessly to an external router; and
a cellular data module;
one or more communication ports connected to the at least one computer processor and at least one of the plurality of interface modules, wherein the machine-readable instructions executable by the at least one computer processor include instructions for:
a) sending or receiving communications, including communications defined by a category of communication selected from the group consisting of:
i. sending the telemetric data to a telemetric data collection/remote support node;
ii. receiving remote support communications from the telemetric data collection/remote support node;
iii. receiving updates to the machine-readable instructions;
iv. receiving the variable data content;
b) selecting which of the plurality of interface modules to use for sending or receiving each communication based on the category of communication and whether each of the plurality of interface modules is available; and
a variable data content communications sub-system, comprising a content computer processor, a variable data content communicator connected to the content computer processor and in communication with the marking unit, and a content computer memory connected to the content computer processor, the content computer memory programmed with machine-readable instructions for generating variable data content and/or receiving user input corresponding at least in part to the variable data content and for sending variable data content communications to the marking unit.

37. The system of claim 36, wherein the variable data content communication sub-system is configured to:
receive instructions regarding a preferred routing for the variable data content communications;
update the machine-readable instructions residing on the content computer memory to include the preferred routing; and
communicate the variable data content to the marking unit using the preferred routing.

38. The system of claim 37, wherein the marking unit is programmed with the machine-readable instructions to automatically, without human interaction subsequent to the marking unit being connected to a power source, initialize the marking unit by:
automatically determining which of the plurality of communications interface modules is available, including attempting to automatically establish a connection to the telemetric data collection/remote support node via the cellular data module;
automatically receiving any available updates to the machine-readable instructions;
automatically selecting which of a plurality of communications interface modules to use for sending or receiving each communication; and
automatically informing a sender configured to send communications to the marking unit as to the preferred routing of the plurality of communications.

39. The system of claim 36, wherein the variable data content communications sub-system is configured to:
receive instructions from the marking unit regarding a preferred routing of which of a plurality of communications interface modules on the marking unit to use for the variable data content communications;
update the machine-readable instructions residing on the content computer memory to include the preferred routing; and
communicate the variable data content to the marking unit using the preferred routing.

40. The system of claim 36, wherein the variable data content communications device includes machine readable media programmed with machine readable instructions for causing the content computer processor to:
generate variable data content and/or receive user input corresponding at least in part to the variable data content;
receive instructions from the marking unit regarding a preferred routing of which of a plurality of communications interface modules on the marking unit to use for sending variable data content communications;
update the machine-readable instructions to include the preferred routing; and
communicate the variable data content to the marking unit using the preferred routing.
